(19) United States
(12) Patent Application Publication
(10) Pub. No.: US 2023/0283385 A1
(43) Pub. Date: Sep. 7, 2023

(54) DATA TRANSMISSION-TOLERANT DISTRIBUTED ACOUSTIC SENSING USING CHIRPED-PULSES WITH TIME-DOMAIN ROLL OFF

(71) Applicant: NEC Laboratories America, Inc., Princeton, NJ (US)

(72) Inventors: Ezra IP, West Windsor, NJ (US); Yue-Kai HUANG, Princeton, NJ (US); Thomas FERREIRA de LIMA, Princeton, NJ (US)

(73) Assignee: NEC LABORATORIES AMERICA, INC, Princeton, NJ (US)

(21) Appl. No.: 18/110,368

(22) Filed: Feb. 16, 2023

Related U.S. Application Data
(60) Provisional application No. 63/311,505, filed on Feb. 18, 2022.
(60) Provisional application No. 63/311,521, filed on Feb. 18, 2022.

(51) Int. Cl. H04B 10/80; G01M 5/00

(52) U.S. Cl. CPC H04B 10/80; G01M 5/0066; G01M 5/0091

(57) ABSTRACT

Aspects of the present disclosure describe distributed fiber optic sensing (DFOS)/distributed acoustic sensing (DAS) systems, methods, and structures that advantageously employ chirped interrogation pulses (sensing signals) that exhibit a smooth amplitude profile produced by appending leading and trailing edges of the sensing signals with out-of-band chirps. By appending leading and trailing out-of-band signals to a chirped pulse sensing signal to produce a “smooth” amplitude profile a coexistence of sensing and telecommunications signals on a same optical fiber is facilitated.

### CROSS REFERENCE

This application claims the benefit of U.S. Provisional Patent Application Ser. No. 63/311,505 filed 18 Feb. 2022 the entire contents of which being incorporated by reference as if set forth at length herein.

### TECHNICAL FIELD

This disclosure relates generally to distributed fiber optic sensing (DFOS) systems, methods, and structures that utilize chirped pulses with time-domain roll off

### BACKGROUND

Recently, DFOS systems and methods have been employed to provide superior acoustic and/or vibrational monitoring of roadways, bridges, and buildings. The reliability, robustness, and sensitivity of such systems is generally known to be unmatched by existing, legacy systems and methods. More recently, distributed acoustic sensing (DAS) using chirped-pulses has gained popularity owing to the ability to increase signal-to-noise ratio (SNR) of a returned backscatter signal without sacrificing spatial resolution or increasing the peak power of interrogation signals. Given the importance of chirped-pulse techniques to DFOS/DAS, improvements thereto would represent a welcome addition to the art.

### SUMMARY

An advance in the art is made according to aspects of the present disclosure directed to DFOS/DAS systems, methods, and structures that employ chirped interrogation pulses (sensing signals).

In sharp contrast to the prior art, the sensing signals according to the present disclosure exhibit a smooth amplitude profile produced by appending leading and trailing edges of the sensing signals with out-of-band chirps.

This inventive feature of appending leading and trailing out-of-band signals to a chirped pulse sensing signal to produce a “smooth” amplitude profile—according to the present disclosure—advantageously facilitates coexistence of sensing and telecommunications signals on a same optical fiber.

### BRIEF DESCRIPTION OF THE DRAWING

A more complete understanding of the present disclosure may be realized by reference to the accompanying drawing in which:

FIG. 1(A) is a schematic diagram illustrating a DFOS system according to aspects of the present disclosure;

FIG. 1(B) is a schematic diagram illustrating a coded constant-amplitude DFOS system with out-of-band signal generation according to aspects of the present disclosure;

FIG. 2(A) and FIG. 2(B) are time- and frequency-domain representations of: FIG. 2(A) sensing signals in conventional N-fold frequency diversity chirped-pulse DAS, where each chirp CPᵢ has duration T_{c} and bandwidth αT_{c}. The amplitude profile is rectangular of duration NT_{c} and the signal has a bandwidth of NαT_{c}.; and FIG. 2(B) Time- and frequency-domain representation of a sensing signal, where out-of-band signals are inserted before and after the conventional sensing signal, producing a smooth amplitude profile. The signals of duration Tᵣₜ in the rising and falling edges must be outside of the bandwidth occupied by CP₁ to CP_{N} and the resulting signal will have longer duration and wider bandwidth, but due to reduced XPM on telecommunications signals, a higher peak power Pₛₑₙₛ can be launched as an interrogation (sensing) signal without deleterious effects on the telecommunications signals according to aspects of the present disclosure;

FIG. 3(A) and FIG. 3(B) are plots illustrating improved nonlinear tolerance from utilizing a smooth amplitude profile by appending out-of-band chirps to a frequency-diversity chirped-pulse interrogation (sensing) (N=20, T_{c}=10 μs, B=10 MHZ, Tₚ=10.5 ms) wherein FIG. 3(A) shows post-FEC BER measured by a real-time coherent transponder vs. peak power Pₛₑₙₛ of the sensing signal for various rise-times Tᵣₜ XPM nonlinearity created by the sensing signal causes cycle slips and burst errors which are not corrected by the FEC of the coherent transponder and Increasing Tᵣₜ increases the maximum tolerable Pₛₑₙₛ at which post-FEC BER is zero; and FIG. 3(B) shows Maximum tolerable Pₛₑₙₛ vs. Tᵣₜ according to aspects of the present disclosure; and

FIG. 4 is a schematic diagram illustrating an experimental setup for evaluating systems and methods according to aspects of the present disclosure.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGS. comprising the drawing are not drawn to scale.

By way of some additional background, we begin by noting that distributed fiber optic sensing (DFOS) is an important and widely used technology to detect environmental conditions (such as temperature, vibration, acoustic excitation vibration, stretch level etc.) anywhere along an optical fiber cable that in turn is connected to an interrogator. As is known, contemporary interrogators are systems that generate an input signal to the fiber and detects/analyzes the reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. DFOS can also employ a signal of forward direction that uses speed differences of multiple modes. Without losing generality, the following description assumes reflected signal though the same approaches can be applied to forwarded signal as well.

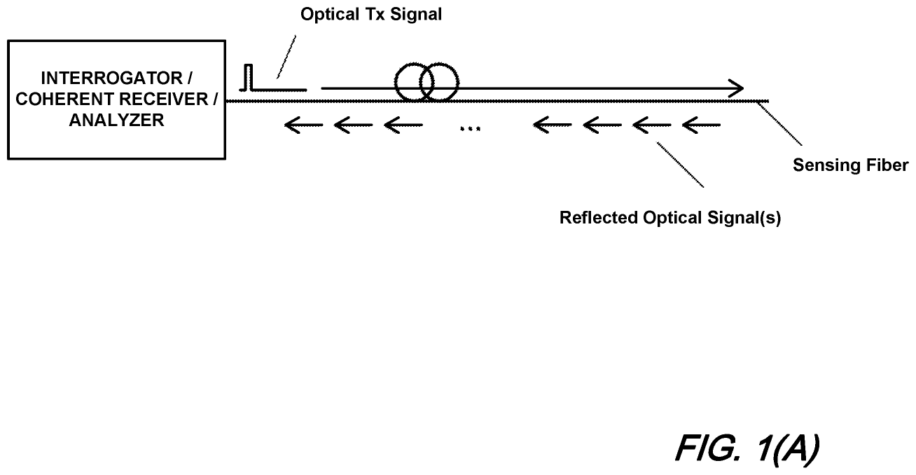

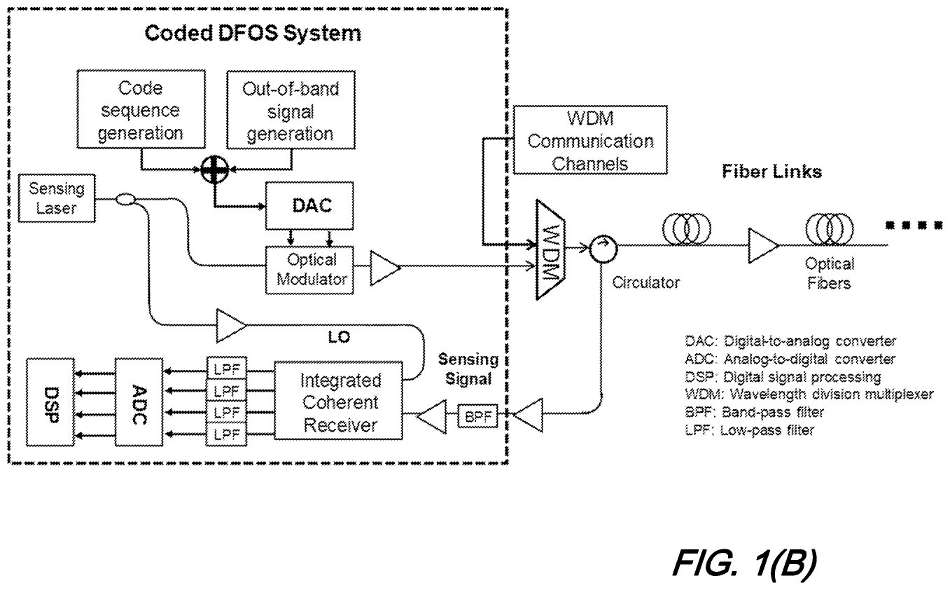

FIG. 1(A) is a schematic diagram of a generalized, prior-art DFOS system. As will be appreciated, a contemporary DFOS system includes an interrogator that periodically generates optical pulses (or any coded signal) and injects them into an optical fiber. The injected optical pulse signal is conveyed along the optical fiber.

At locations along the length of the fiber, a small portion of signal is reflected and conveyed back to the interrogator. The reflected signal carries information the interrogator uses to detect, such as a power level change that indicates—for example—a mechanical vibration. While not shown in detail, the interrogator may include a coded DFOS system that may employ a coherent receiver arrangement known in the art such as that illustrated in FIG. 1(B).

The reflected signal is converted to electrical domain and processed inside the interrogator. Based on the pulse injection time and the time signal is detected, the interrogator determines at which location along the fiber the signal is coming from, thus able to sense the activity of each location along the fiber.

Those skilled in the art will understand and appreciate that by implementing a signal coding on the interrogation signal enables the sending of more optical power into the fiber which can advantageously improve signal-to-noise ratio (SNR) of Rayleigh-scattering based system (e.g. distributed acoustic sensing or DAS) and Brillouin-scattering based system (e.g. Brillouin optical time domain reflectometry or BOTDR).

As currently implemented in many contemporary implementations, dedicated fibers are assigned to DFOS systems in fiber-optic cables—physically separated from existing optical communication signals which are conveyed in different fiber(s). However, given the explosively growing bandwidth demands, it is becoming much more difficult to economically operate and maintain optical fibers for DFOS operations only. Consequently, there exists an increasing interest to integrate communications systems and sensing systems on a common fiber that may be part of a larger, multi-fiber cable.

Operationally, we assume that the DFOS system will be Rayleigh-scattering based system (e.g., distributed acoustic sensing or DAS) and Brillouin-scattering based system (e.g., Brillouin optical time domain reflectometry or BOTDR) with a coding implementation. With such coding designs, these systems will be most likely be integrated with fiber communication systems due to their lower power operation and will also be more affected by the optical amplifier response time.

In the arrangement illustratively shown in the block diagram, we assume that the coded interrogation sequence is generated digitally and modulated onto the sensing laser via digital-to-analog-conversion (DAC) and an optical modulator. The modulated interrogation sequence may be amplified to optimal operation power before being directed into the fiber for interrogation.

Advantageously, the DFOS/DAS operation may also be integrated together with communication channels in the same fiber.

As previously noted, distributed acoustic sensing (DAS) using chirped-pulses has recently gained popularity owing to the ability to increase signal-to-noise ratio (SNR) of the returned backscatter without sacrificing spatial resolution or increasing the peak power of the sensing signal. Such chirped-pulse DAS has also been called “time-gated domain orthogonal frequency-domain reflectometry” (TGD-OFDR).

The basis for spatial resolution preservation is that a chirped pulse

$$p ( t ) = \sqrt{{P}_{sens}} exp ( j 2 π α \frac{{t}^{2}}{2} ) rect ( \frac{t}{{T}_{c}} )$$

with peak power Pₛₑₙₛ, duration T_{c} and bandwidth B=αT_{c}, where γ is the chirp factor, has a “narrow” autocorrelation function Rₚₚ(t)=(T_{c}−|t|)sin c(γt(T_{c}−|t|)) whose main lobe has transform-limited width of 1/B. This enables the use of correlation detection to recover the Rayleigh impulse response of the fiber under test (FUT).

Chirped-pulse DAS has achieved repeaterless reach of some 171 km, while recent field trial result to be published employing this technique has yielded a reach of over 1,000 over an all-Raman amplified link.

One problem with using a conventional chirped-pulse with rectangular envelope as described by p(t) is that the sharp transition in signal amplitude at the beginning and end of the pulse will induce large nonlinear penalty on co-propagating telecom channels. This is analogous to legacy on-off-keying (OOK) signals imposing large cross-phase modulation (XPM) penalty on coherent telecom signals. Since sensing signals have much lower bandwidth than telecom signals, we can to a first order neglect chromatic dispersion in considering the nonlinear impact of sensing signals on telecom signals.

Assume a link with Nₛₚₐₙ identical spans of fiber, each with effective nonlinear length of L_{eff}. Also assume the sensing channel is adjacent to a telecommunications channel of interest so “walkoff” is also neglected. Kerr nonlinearity will cause the sensing signal to induce a nonlinear phase of ϕ_{NL}(t)=γNₛₚₐₙL_{eff}|p(t)|² on the telecom signal.

Thus, at the beginning and end of the chirped sensing pulse, the nonlinear phase will rapidly change from 0 to γNₛₚₐₙL_{eff}Pₛₑₙₛ over a time scale ˜1/B, which is too fast for the carrier phase recovery (CPR) in a coherent receiver to track. This may lead to cycle slips, causing burst errors, and if an interleaver employed in the forward-error correction (FEC) is insufficiently long, the burst errors will not be sufficiently randomized, which may lead to non-zero post-FEC bit-error rate (BER) even if the pre-FEC BER is below threshold.

In summary, XPM imposed by the sensing signal on telecommunications channels can cause the telecom channels to “stop working” (non-zero post-FEC BER).

One way for the sensing channel to coexist with telecom channels is to reduce Pₛₑₙₛ until the post-FEC of the telecom channel is zero but reducing Pₛₑₙₛ also reduces the SNR of the Rayleigh backscatter received by the sensing transponder.

According to aspects of the present disclosure, our inventive systems and methods employ a modified sensing signal with smooth amplitude profile to reduce deleterious nonlinear effects on co-propagating telecom signals. This is accomplished by appending leading and trailing edges around the sensing signal and filling them with out-of-band chirps.

The inventive feature—appending leading and trailing out-of-band signals to a chirped-pulse sensing signal—ensures its amplitude profile is “smooth”, thus reducing the nonlinear penalty imposed on telecommunications signals, which facilitates the coexistence of both sensing and telecommunications signals on the same optical fiber.

An alternative method of mitigating the nonlinear penalty on data transmission is to use a sensing signal with a smooth amplitude profile. Since the XPM nonlinear phase induced by the sensing signal, ϕ_{NL}(t)=γNₛₚₐₙL_{eff}|p(t)|², is proportional to instantaneous power, by making |p(t)|² vary slowly, it is possible to ensure ϕ_{NL}(t) changes slow enough that the CPR of the coherent telecom transponder can track it without becoming unlocked, thus reducing the probability of cycle slips and burst errors.

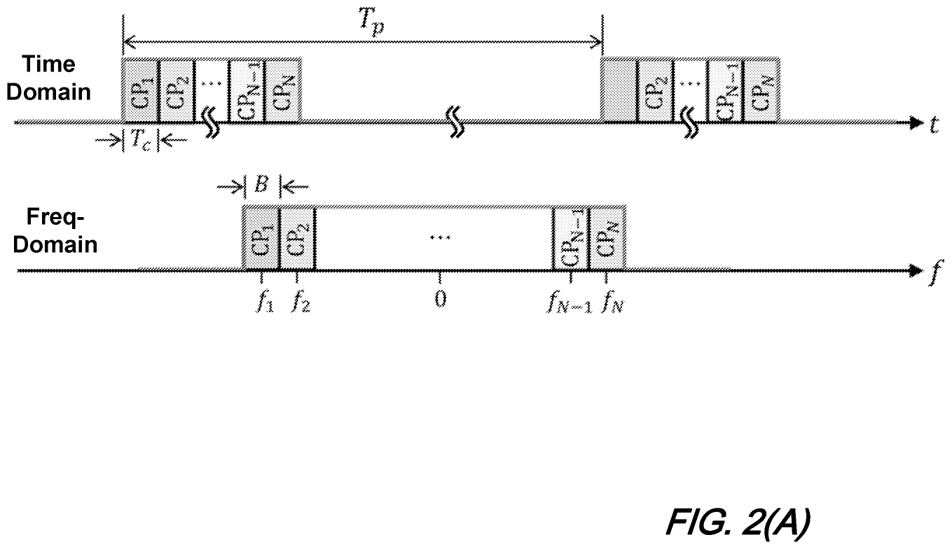

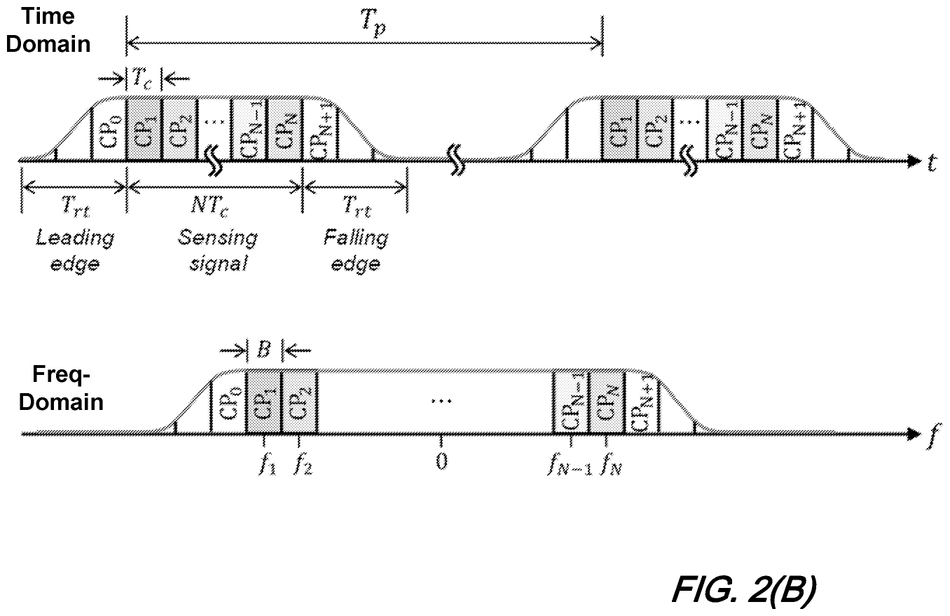

According to aspects of the present disclosure, we employ a sensing signal such as that illustratively shown in FIG. 2(B), wherein the normal, conventional signal is illustratively shown in FIG. 2(A). Note we have assumed the use of N-fold frequency diversity, where each CPᵢ is a chirped pulse of the form p(t) modulated by center frequency fᵢ. The CPᵢ are launched consecutively in time, at an overall repetition rate of Tₚ that is greater than the round-trip propagation time of the fiber under test (FUT). The amplitude profile of the launched signal is rectangular and exhibits a duration NT_{c}. The frequency-domain representation of the signal is also shown.

We modify the sensing signal by inserting out-of-band signals before CP₁ and after CP_{N} so that the amplitude profile becomes smooth, with rise-time and fall-time given by Tᵣₜ.

FIG. 2(A) and FIG. 2(B) are time- and frequency-domain representations of: FIG. 2(A) sensing signals in conventional N-fold frequency diversity chirped-pulse DAS, where each chirp CPᵢ has duration T_{c} and bandwidth αT_{c}. The amplitude profile is rectangular of duration NT_{c} and the signal has a bandwidth of NαT_{c}.; and FIG. 2(B) Time- and frequency-domain representation of a sensing signal, where out-of-band signals are inserted before and after the conventional sensing signal, producing a smooth amplitude profile. The signals of duration Tᵣₜ in the rising and falling edges must be outside of the bandwidth occupied by CP₁ to CP_{N} and the resulting signal will have longer duration and wider bandwidth, but due to reduced XPM on telecommunications signals, a higher peak power Pₛₑₙₛ can be launched as an interrogation (sensing) signal without deleterious effects on the telecommunications signals according to aspects of the present disclosure;

FIG. 2(B) shows one illustrative construction where the amplitude profile of the out-of-band is a raised-cosine. Other illustrative constructions such as a ramp function are also possible—the only requirement is that the function should be smooth in order that ϕ_{NL}(t) changes slowly. The signal underneath the rise-time and fall-time must be outside the bandwidth of the sensing signal CP₁ to CP_{N} in order not to interfere with the DAS function.

In FIG. 2(B), we show a particular construction where we use out-of-band chirps CP₀, CP₋₁, CP_{N+1}, centered at f₀, f₋₁, f_{N+1}. Other out-of-band signals can be used if its amplitude is a smooth function shown by outline curve.

Advantageously, our inventive method was recently tested over a 1,000 km fiber link with all-Raman amplification, where the sensing signal co-propagated with 50×200-Gb/s DP-16QAM data channels. The increase in nonlinear tolerance is significant and we first measured the posts-FEC BER of a real-time coherent transponder that is 50 GHz away from the sensing signal.

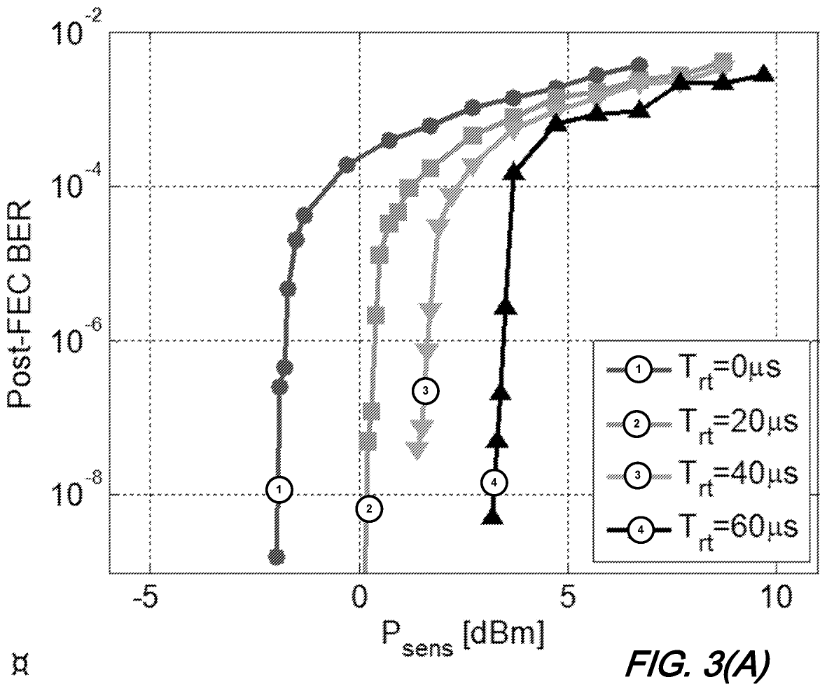

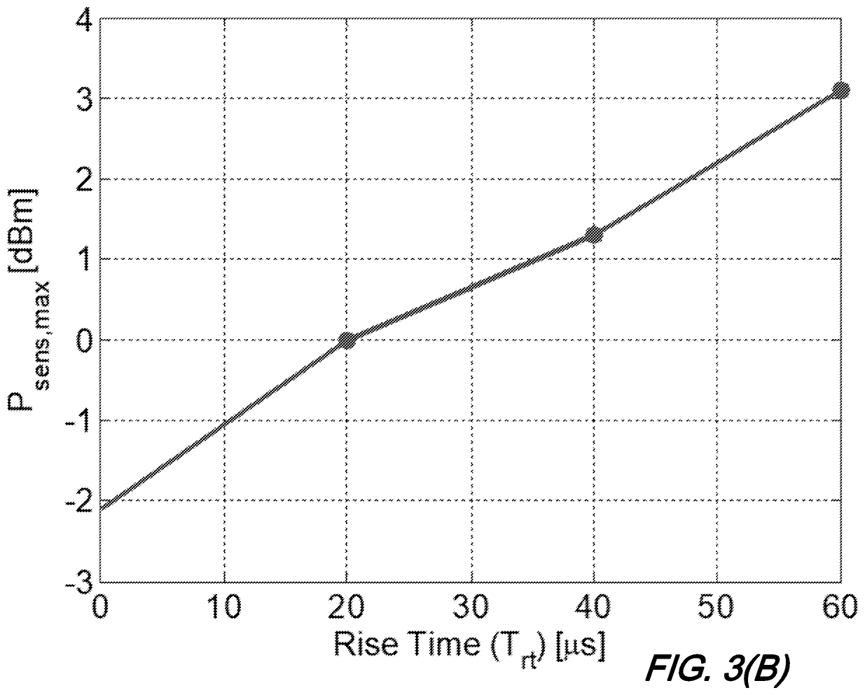

FIG. 3(A) and FIG. 3(B) are plots illustrating improved nonlinear tolerance from utilizing a smooth amplitude profile by appending out-of-band chirps to a frequency-diversity chirped-pulse interrogation (sensing) (N=20, T_{c}=10 μs, B=10 MHZ, Tₚ=10.5 ms) wherein FIG. 3(A) shows post-FEC BER measured by a real-time coherent transponder vs. peak power Pₛₑₙₛ of the sensing signal for various rise-times Tᵣₜ XPM nonlinearity created by the sensing signal causes cycle slips and burst errors which are not corrected by the FEC of the coherent transponder and Increasing Tᵣₜ increases the maximum tolerable Pₛₑₙₛ at which post-FEC BER is zero; and FIG. 3(B) shows Maximum tolerable Pₛₑₙₛ vs. Tᵣₜ according to aspects of the present disclosure;

As may be observed in FIG. 2(B), when Pₛₑₙₛ is large, burst errors caused by cycle slips are not corrected by the FEC, resulting in non-zero post-FEC BER. As Pₛₑₙₛ is reduced, there is a threshold below which post-FEC BER becomes zero. The maximum tolerable peak power of the sensing signal, Pₛₑₙₛ, is dependent on Tᵣₜ. It is observed in FIG. 2(B) that as Tᵣₜ is increased from 0 to 60 μs (equal to 3T_{c}), P_{sens,max} is increased from −2 dBm to +3 dBm.

### Experimental Setup

As we have noted previously, the use of the telecommunications optical fiber infrastructure for distributed sensing has gained increased attention among service providers, as it enables new revenue sources for telecommunications service providers/operators, while facilitating public safety and smarter cities. Co-existence with data transmission and sensing has been demonstrated in.

In particular, distributed acoustic sensing (DAS) based on phase optical time-domain reflectometry (φ-OTDR) of Rayleigh backscatter allows such applications as traffic monitoring, intrusion detection, seismic monitoring, etc. To date, DAS has mostly been conducted over tens of kilometers of fiber due to optical signal-to-noise ratio (OSNR) constraints. It is desirable to increase the reach of DAS to be more comparable with long-haul data transmission, as this could reduce the number of required sensing transponders over a given geographic area and allow early warning of offshore earthquakes in submarine cables.

According to aspects of the present disclosure, we employ all-Raman amplification without inline isolators and use frequency-diversity chirped-pulse DAS (FD-CP-DAS) with correlation detection and diversity combining. We now report our first-ever DAS results over >1,000 km of standard single-mode fiber (SSMF) using an all backward-pumped Raman amplification scheme.

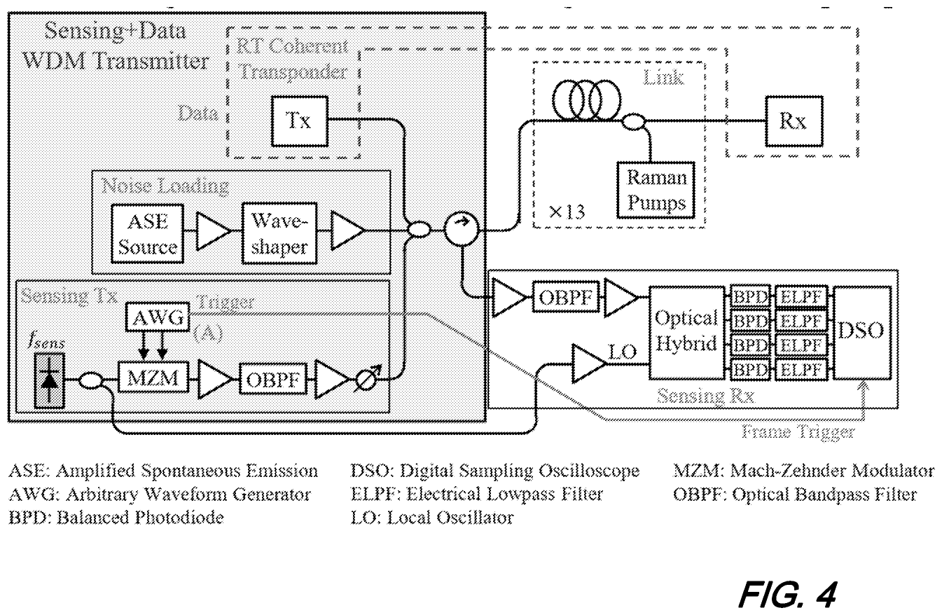

The experimental setup is shown schematically in FIG. 4. As shown in that figure, at the transmitter, a sensing signal is generated by passing a low phase noise NKT X15 fiber laser at 1550.112 nm through a Mach-Zehnder I/Q modulator (MZM) driven with an arbitrary waveform generator (AWG) operating at 1 GSa/s. The sensing signal generated comprises of 20×frequency-diversity chirped pulses (CP), each with bandwidth B=10 MHz (spatial resolution z≈10 m) and duration of T=10 ns.

The 20 CP's centered at f are launched consecutively, their mutual frequency spacing at Δf=B. The repetition period was set to T=10.5 ms to allow an interrogation distance >1,000 km).

The theoretical OSNR gain over single-frequency non-chirped DAS at the same spatial resolution is 33 dB: 20 dB from correlation detection, and 13 dB from frequency-diversity. To reduce cross-phase modulation (XPM) distortion on telecom signals (like the XPM effect observed for the co-propagation of legacy on-off-keying signals with coherent signals), we insert append rising and falling edges of duration T using out-of-band chirps to create a smooth amplitude profile.

For the data channel, we used a real-time 32 GHz DP-16QAM coherent transponder supporting 200-Gb/s data rate per channel. The co-propagation of 50 dense wavelength-division multiplexed (DWDM) data channels from 191.75 THz to 194.25 THz was emulated using noise loading, where an amplified spontaneous emission (ASE) noise source is amplified by a two-stage EDFA with a wavelength-selective switch (WSS) at the mid-stage, which simultaneously equalizes the transmitted spectrum and combines the emulated WDM neighbors, 200G channel under test (CUT) and the sensing signal.

The link comprises of 13 spans of standard single-mode fiber (SSMF). The first 10 spans are lab fibers. Spans 11 and 12 comprise two loops of a 79.8-km long field fiber in the North Dallas pool previously reported in. Span 13 comprise of loopbacks of two more field fibers 2 5.5-km and 2 9.3-km long, followed by two 10.1-km spans of lab fibers. To enable Rayleigh back reflection to travel back to the transponder, all-Raman amplification was used. Spans 1 to 10 (avg. span length: 79.7 km, avg. span loss: 16.5 dB) and Span 13 used backward-pumping. The higher loss Spans 11 and 12 with losses of 19.9 and 20.9 dB used forward and backward Raman pumping. The power of the Raman pumps (from 1426 to 1466 nm) were adjusted to equalize the loss of the previous span while maximizing gain flatness.

The WDM signal was launched into link at +14 dBm (3 dBm/ch), while the sensing signal was launched at 14.2 dBm (Peak power: +2.2 dBm).

The received Rayleigh backscatter was passed through an EDFA pre-amp, followed by a 0.1-nm optical bandpass filter (OBPF), followed by another EDFA pre-amp. The resulting signal was detected using a conventional coherent receiver comprising a dual-polarization optical hybrid followed by balanced photodiodes (BPD), followed by 110-MHz electrical lowpass filters (ELPF), followed by sampling and digitization by a digital sampling oscilloscope (DSO) operating at 250 MSa/s. The DSO was operated in sequential capture mode where the frame-rate trigger was provided by the AWG. We acquired N=2,000 frames per data set where every frame contains 200 μs of data (100 MSamples per data set). Vibrations up to the Nyquist frequency of 50 Hz can be observed at a frequency resolution of 1/N T=0.05 Hz. For the data channels, pre- and post-forward error correction (FEC) bit-error rates (BER) were measured by the receiver of the real-time transponder.

### Experimental Results

First, we measured the Rayleigh impulse response at each sensing channel by correlation detection. An approximate power profile of the link can be observed with spikes—due to reflection at connectors. Stronger reflections were observed at SC-PC than FC-APC connectors.

To reduce “spatial leakage”, we compute differential beat products are calculated at twice the minimum gauge time set by the bandwidth of each CP, i.e., i=2/R=0.2 μs. After timing realignment, the beat products are optimally combined using the rotated-vector-sum, yielding a complex-valued ζ[n, m] where n and m are the distance and frame indices, respectively. Taking unwrapped angle at each fiber position n yields the estimated strain-induced optical phase shift at that position.

To demonstrate spatial resolution, we inserted a 1.5-m and a 12-m long piezoelectric transducer (PZT) were inserted near the end of Span 10. The PZTs were driven with sine waves at 16 Hz and 27 Hz, respectively. No spatial crosstalk was observed and phase noise is approximately flat over 10 to 48 Hz, but rises at low frequencies due to phase noise of the laser. We estimate the phase noise power spectral density (PSD) floor in rad Hz over the flat region from 15 Hz to the Nyquist frequency R 2. By capturing data centered over different points in link, we obtain the sensitivity vs distance sweep at 1 km resolution. Large phase noise PSD observed in Spans 11, 12, and the first half of Span 13 was caused by real-world vibrations.

In this experiment we conducted the first >1,000 km DAS experiment using FD-CP-DAS with correlation detection and diversity combining. An all-Raman amplification scheme allowed Rayleigh backscatter to travel back to the sensing transponder. The sensing signal co-existed with 10-Tb/s data transmission, emulated with a real-time DP-16QAM transponder and noise loading. All data channels achieved zero BER after FEC decoding, while a sensing performance of ˜100 pHz was achieved at a gauge length of 20 meters. The DAS also successfully recovered the waveform of real-world vibration events

At this point, while we have presented this disclosure using some specific examples, those skilled in the art will recognize that our teachings are not so limited. Accordingly, this disclosure should only be limited by the scope of the claims attached hereto.

1.-10. (canceled)

11. (canceled)

11. (canceled)

13.-20. (canceled)

21. A distributed fiber optic sensing (DFOS)/distributed acoustic sensing (DAS) system comprising:
a length of optical fiber sensor cable;
a DFOS/DAS interrogator in optical communication with the length of optical fiber sensor cable;
said DFOS/DAS interrogator configured to
generate probe signals and launch the generated probe signals into the length of optical fiber sensor cable; and
receive Rayleigh backscatter signals from the optical fiber sensor cable;
the distributed fiber optic sensing (DFOS) system CHARACTERIZED IN THAT:
the probe signals have a leading and trailing edge appended thereto before launching such that the probe signals including the leading and trailing edge exhibit a smooth amplitude profile.

22. The system of claim 21 wherein the probe signals include chirped pulses.

23. The system of claim 22 wherein the probe signals include a concatenation of chirped pulses each centered over a different center frequency.

24. The system of claim 23 wherein the leading and trailing edges are chirped pulses having a center frequency outside the frequencies of the concatenated chirped pulses.

25. The system of claim 24 wherein the optical fiber sensor cable simultaneously carries telecommunications traffic.

26. The system of claim 25 wherein the telecommunications traffic is conveyed in the optical fiber sensor cable as wavelength division multiplexed (WDM) optical signals.

27. The system of claim 23 wherein the leading and trailing edges exhibit a raised-cosine amplitude profile.

28. The system of claim 23 wherein the leading and trailing edges exhibit a ramp function amplitude profile.

29. The system of claim 23 wherein the probe pulses exhibit an N-fold frequency diversity, where each chirped pulse (CPi) is a chirped pulse of the form p (t) modulated by a center frequency fi.

30. The system of claim 29 wherein the CPi are launched consecutively in time at an overall repetition rate of Tp that is greater than a round-trip propagation time for the optical fiber sensor cable.

31. A method for performing distributed fiber optic sensing (DFOS/distributed acoustic sensing (DAS) comprising:
providing a length of optical sensor fiber;
providing a DFOS/DAS interrogator in optical communications with the optical sensor fiber, said DFOS/DAS interrogator configured to generate optical probe pulses, introduce the generated probe pulses into the length of optical sensor fiber and receive backscattered signals from the length of optical sensor fiber, and
providing an intelligent analyzer configured to analyze the backscattered signals and determine from the backscattered signals environmental conditions occurring at locations along the length of the optical sensor fiber;
wherein the probe signals have a leading and trailing edge appended thereto before being introduced into the length of optical sensor fiber such that the probe signals including the leading and trailing edge exhibit a smooth amplitude profile.

32. The method of claim 31 wherein the probe signals include chirped pulses.

33. The method of claim 31 wherein the probe signals include a concatenation of chirped pulses each centered over a different center frequency.

34. The method of claim 32 wherein the leading and trailing edges are chirped pulses having a center frequency outside the frequencies of the concatenated chirped pulses.

35. The method of claim 33 wherein the optical fiber sensor cable simultaneously carries telecommunications traffic.

36. The method of claim 34 wherein the telecommunications traffic is conveyed in the optical fiber sensor cable as wavelength division multiplexed (WDM) optical signals.

37. The method of claim 33 wherein the leading and trailing edges exhibit a raised-cosine amplitude profile.

38. The method of claim 33 wherein the leading and trailing edges exhibit a ramp function amplitude profile.

39. The method of claim 33 wherein the probe pulses exhibit an N-fold frequency diversity, where each chirped pulse (CPi) is a chirped pulse of the form p(t) modulated by a center frequency fi.

40. The method of claim 38 wherein the CPi are launched consecutively in time at an overall repetition rate of Tp that is greater than a round-trip propagation time for the optical fiber sensor cable.

41. The method of claim 39 wherein the WDM telecommunications traffic and the probe pulses are multiplexed into the optical fiber sensor cable.
